(19) United States
(12) Patent Application Publication
(10) Pub. No.: US 2025/0201841 A1
(43) Pub. Date: Jun. 19, 2025

(54) ELECTRODE SLURRY FOR ELECTROCHEMICAL ENERGY STORAGE DEVICE

(71) Applicant: POLYBATT MATERIAL CO., LTD., Tainan City (TW)

(72) Inventors: PING-LIN KUO, Tainan City (TW); CHIH-HAO TSAO, Tainan City (TW)

(73) Assignee: POLYBATT MATERIAL CO., LTD., Tainan City (TW)

(21) Appl. No.: 18/950,210

(22) Filed: Nov. 18, 2024

(30) Foreign Application Priority Data
Dec. 14, 2023 (TW) 112148736

(51) Int. Cl. H01M 4/62; H01M 4/02

(52) U.S. Cl. CPC H01M 4/62; H01M 2004/028

(57) ABSTRACT

An electrode slurry for electrochemical energy storage devices includes one or more compounds or polymers that can form a stable structure of Formula (I) as shown below: X—O^{●} Formula (I), wherein X can resonate with —O^{●} to stabilize the structure of Formula (I). The electrode slurry described above, wherein X may be an organic moiety selected from

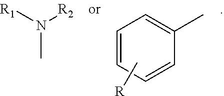

### CROSS-REFERENCE TO RELATED APPLICATION

This non-provisional application claims priority under 35 U.S.C. § 119(a) on Patent Application No(s). 112148736 filed in Taiwan, R.O.C. on Dec. 14, 2023, the entire contents of which are hereby incorporated by reference.

### BACKGROUND OF THE INVENTION

### 1. Field of the Invention

The present disclosure relates to an electrode slurry for electrochemical energy storage devices, and in particular to an electrode slurry for electrochemical energy storage devices, which includes one or more compounds or polymers that can form a stable structure of Formula (I) as shown below: X—O^{●} Formula (I), wherein X can resonate with —O^{●} to stabilize the structure of Formula (I).

### 2. Description of the Related Art

Electrochemical energy storage devices are widely used in various electronic products. The physical and chemical properties of the electrode slurry used in electrochemical energy storage devices have a certain impact on the charge and discharge performance of the electrochemical energy storage device. In particular, the viscosity of the electrode slurry and the changing trend of the viscosity of the electrode slurry over time have a considerable impact on the ease of manufacturing the electrochemical energy storage device as well as the yield and life of the product.

Prior art attempts have been made to add compounds or polymers to electrode slurries for electrochemical energy storage devices to improve their viscosity properties. However, there is still room for improvement in terms of viscosity control of prior art electrode slurries used in electrochemical energy storage devices.

### BRIEF SUMMARY OF THE INVENTION

There is still room for improvement in terms of viscosity control of electrode slurries used in electrochemical energy storage devices in the prior art. Therefore, an object of the present disclosure is to provide a novel electrode slurry for electrochemical energy storage devices, which can effectively control the residual alkali and its side reactions of the positive electrode active material, and has good viscosity properties.

To achieve the above and other objects, the present disclosure provides an electrode slurry for an electrochemical energy storage device, which includes: one or more compounds or polymers that can form a structure of Formula (I) as shown below:

X—O^{●} Formula (I)
wherein X can resonate with —O^{●} to stabilize the structure of Formula (I).

The electrode slurry described above, wherein X is an organic moiety selected from

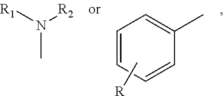

wherein R₁ and R₂ are substituents selected from the group consisting of linear or cyclic alkyl groups, aryl groups and derivatives thereof,
wherein R is a substituent selected from the group consisting of alkyl group, carboxyl group, carbonyl group, hydroxyl group and derivatives thereof.

The electrode slurry described above, wherein lithium, sodium or a compound thereof may be further comprised.

The electrode slurry described above, wherein a polymer or a copolymer derived from vinylidene fluoride (VDF) and/or acrylonitrile (AN) monomers may be further comprised.

The electrode slurry described above, wherein the copolymer may have a structure as shown below:

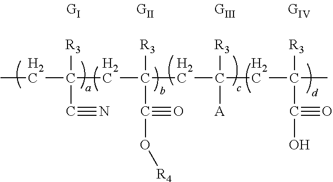

wherein:
G_{I} is derived from acrylonitrile;
G_{II} is derived from acrylate or methacrylate, and R₄ is a linear alkyl group;
G_{III} is derived from a vinylactam compound, A is a cyclic amide group;
G_{IV} is derived from acrylic acid;
wherein R₃ is H or CH₃;
wherein a number of a repeating unit of the copolymer meets the following conditions:

$$\frac{a}{a + b + c + d} > 0 ‵ \frac{b}{a + b + c + d} > 0 ‵ \frac{c}{a + b + c + d} \geq 0 ‵ \frac{d}{a + b + c + d} \geq 0.$$

The electrode slurry described above, wherein based on a total weight of the copolymer, G_{I} may be 50 to 98 wt %, G_{II} may be 0.5 to 20 wt %, G_{III} may be 0.5 to 20 wt %, and G_{IV} may be 0.5 to 20 wt %; wherein G_{III} may be derived from vinylpyrrolidone.

The electrode slurry described above, wherein based on a solid weight of the electrode slurry, the compound or the polymer may be 0.001 to 10 wt %.

The electrode slurry described above, wherein the compound containing oxygen, nitrogen or sulfur may be selected from the group consisting of, but is not limited to, compounds with the following types of functional groups, such as aldehydes: formaldehyde, acetaldehyde, propionaldehyde, butyl aldehyde, cinnamic aldehyde, glucose, benzaldehyde; piperidines or pyrrolidines: tetrahydropyrrole, pyrroline, pyrrole, hexahydropiperidine, tetramethylpiperidine oxide, N-methylpiperidine-2-ethanol, R-3-aminopiperidine hydrochloride; phenols: phenol, polyphenols, hydroquinone, bisphenol A, dibutylhydroxytoluene, 2-methylphenol, 2-isopropyl-5-methyl phenol, hindered phenol, xylenol, hydroquinone monomethyl ether, propofol, nonylphenol, cresol, salicylic acid, methyl salicylate, phenolic resin and its derivatives; nitriles: carbonitrile, acetonitrile, hydrogen cyanide, cyanic acid, cyanuric acid, thiocyanic acid, malononitrile, succinonitrile, acrylonitrile, vitamin B12, potassium ferricyanate, potassium nickel cyanate, potassium cobalt cyanate, Prussian blue, potassium silver cyanide, Potassium dicyanoaurate, potassium cyanide, sodium cyanide, zinc cyanide, silver cyanide, cuprous cyanide, mercury cyanide, nickel cyanide, cobalt cyanide, polyacrylonitrile and ketones: aliphatic ketones, alicyclic ketones and aromatic ketones, acetone, butanone, methyl ethyl ketone, cyclohexanone, butanedione, and acetoacetone.

The electrode slurry described above, wherein the compound or the polymer is preferably selected from the group consisting of compounds containing a phenolic moiety, compounds containing an aminoxide moiety, phenols and derivatives thereof or derived polymers thereof.

The electrode slurry described above, wherein the compound or the polymer is preferably selected from the group consisting of 4-hydroxy-2,2,6,6-tetramethyl-1-piperidine oxide, 4-hydroxy-2,2,6,6-tetramethyl-1-piperidine oxide, tetramethylpiperidine oxide, phenol, polyphenols, hydroquinone and hydroquinone monomethyl ether and derivatives thereof or derived polymers thereof.

Compared with the prior art, the electrode slurry for electrochemical energy storage devices of the present disclosure has better viscosity properties.

### BRIEF DESCRIPTION OF THE DRAWINGS

None

### DETAILED DESCRIPTION OF THE INVENTION

To facilitate understanding of the object, characteristics and effects of this present disclosure, embodiments together with the attached drawings for the detailed description of the present disclosure are provided.

### Example 1

The polyacrylonitrile copolymer used as the anti-gel additive, together with the commercial adhesive (Solvay, 5130), the commercial carbon powder (Super P), the commercial sodium anode material (Medarui, A 107S) and the phenol additive as the auxiliary, were mixed according to a weight ratio of 0.8:3.2:4:92:10, and N-Methyl-2-pyrrolidone (NMP) was used as the solvent, which were stirred for 30 minutes with the rotary degassing machine (Hongyi). The stirred slurry was left to rest, and the change in viscosity over time was observed.

In particular, the phenol additive can form the stable structure as shown in Formula (I) below:

X—O^{●} Formula (I),
wherein X can resonate with —O^{●} to stabilize the structure of Formula (I).

### Example 2

The polyacrylonitrile copolymer used as the anti-gel additive, together with the commercial adhesive (Solvay, 5130), the commercial carbon powder (Super P), the commercial sodium anode material (Medarui, A 107S) and the phenol additive as the auxiliary, were mixed according to a weight ratio of 0.8:3.2:4:92:20, and NMP was used as the solvent, which were stirred for 30 minutes with the rotary degassing machine (Hongyi). The stirred slurry was left to rest, and the change in viscosity over time was observed.

In particular, the phenol additive can form the stable structure as shown in Formula (I) below:

X—O^{●} Formula (I),
wherein X can resonate with —O^{●} to stabilize the structure of Formula (I).

### Example 3

The polyacrylonitrile copolymer used as the anti-gel additive, together with the commercial adhesive (Solvay, 5130), the commercial carbon powder (Super P), the commercial sodium anode material (Medarui, A107S) and the piperidine additive as the auxiliary, were mixed according to a weight ratio of 0.8:3.2:4:92:10, and NMP was used as the solvent, which were stirred for 30 minutes with the rotary degassing machine (Hongyi). The stirred slurry was left to rest, and the change in viscosity over time was observed.

In particular, the piperidine additive can form the stable structure as shown in Formula (I) below:

X—O^{●} Formula (I),
wherein X can resonate with —O^{●} to stabilize the structure of Formula (I).

### Example 4

The polyacrylonitrile copolymer used as the anti-gel additive, together with the commercial adhesive (Solvay, 5130), the commercial carbon powder (Super P), the commercial sodium anode material (Medarui, A107S) and the piperidine additive as the auxiliary, were mixed according to a weight ratio of 0.8:3.2:4:92:20, and NMP was used as the solvent, which were stirred for 30 minutes with the rotary degassing machine (Hongyi). The stirred slurry was left to rest, and the change in viscosity over time was observed.

In particular, the piperidine additive can form the stable structure as shown in Formula (I) below:

X—O^{●} Formula (I),
wherein X can resonate with —O^{●} to stabilize the structure of Formula (I).

### Example 5

The polyacrylonitrile copolymer used as the anti-gel additive, together with the commercial adhesive (Solvay, 5130), the commercial carbon powder (Super P), the commercial sodium anode material (Medarui, A107S) and the hindered phenol additive as the auxiliary, were mixed according to a weight ratio of 0.8:3.2:4:92:10, and NMP was used as the solvent, which were stirred for 30 minutes with the rotary degassing machine (Hongyi). The stirred slurry was left to rest, and the change in viscosity over time was observed.

In particular, the hindered phenol additive can form the stable structure as shown in Formula (I) below:

X—O^{●} Formula (I),
wherein X can resonate with —O^{●} to stabilize the structure of Formula (I).

### Example 6

The polyacrylonitrile copolymer used as the anti-gel additive, together with the commercial adhesive (Solvay, 5130), the commercial carbon powder (Super P), the commercial sodium anode material (Medarui, A107S) and the hindered phenol additive as the auxiliary, were mixed according to a weight ratio of 0.8:3.2:4:92:20, and NMP was used as the solvent, which were stirred for 30 minutes with the rotary degassing machine (Hongyi). The stirred slurry was left to rest, and the change in viscosity over time was observed.

In particular, the hindered phenol additive can form the stable structure as shown in Formula (I) below:

X—O^{●} Formula (I),
wherein X can resonate with —O^{●} to stabilize the structure of Formula (I).

### Example 7

The commercial adhesive (Solvay, 5130), the commercial carbon powder (Super P), the commercial sodium anode material (Medarui, A107S) and the piperidine additive were mixed according to a weight ratio of 3.6:4:92:0.4, and NMP was used as the solvent, which were stirred for 30 minutes with the rotary degassing machine (Hongyi). The stirred slurry was left to rest, and the change in viscosity over time was observed.

In particular, the piperidine additive can form the stable structure as shown in Formula (I) below:

X—O^{●} Formula (I),
wherein X can resonate with —O^{●} to stabilize the structure of Formula (I).

### Example 8

The commercial adhesive (Solvay, 5130), the commercial carbon powder (Super P), the commercial sodium anode material (Medarui, A 107S) and the hindered phenol additive were mixed according to a weight ratio of 3.6:4:92:0.4, and NMP was used as the solvent, which were stirred for 30 minutes with the rotary degassing machine (Hongyi). The stirred slurry was left to rest, and the change in viscosity over time was observed.

In particular, the hindered phenol additive can form the stable structure as shown in Formula (I) below:

X—O^{●} Formula (I),
wherein X can resonate with —O^{●} to stabilize the structure of Formula (I).

### Example 9

The commercial adhesive (Solvay, 5130), the commercial carbon powder (Super P), the commercial sodium anode material (Medarui, A107S) and the piperidine additive were mixed according to a weight ratio of 3.2:4:92:0.8, and NMP was used as the solvent, which were stirred for 30 minutes with the rotary degassing machine (Hongyi). The stirred slurry was left to rest, and the change in viscosity over time was observed.

In particular, the piperidine additive can form the stable structure as shown in Formula (I) below:

X—O^{●} Formula (I),
wherein X can resonate with —O^{●} to stabilize the structure of Formula (I).

### Example 10

The commercial adhesive (Solvay, 5130), the commercial carbon powder (Super P), the commercial sodium anode material (Medarui, A 107S) and the hindered phenol additive were mixed according to a weight ratio of 3.2:4:92:0.8, and NMP was used as the solvent, which were stirred for 30 minutes with the rotary degassing machine (Hongyi). The stirred slurry was left to rest, and the change in viscosity over time was observed.

In particular, the hindered phenol additive can form the stable structure as shown in Formula (I) below:

X—O^{●} Formula (I),
wherein X can resonate with —O^{●} to stabilize the structure of Formula (I).

### Example 11

The commercial adhesive (Solvay, 5130), the commercial carbon powder (Super P), the commercial sodium anode material (Medarui, A107S) and the benzenediol additive were mixed according to a weight ratio of 3.6:4:92:0.4, and NMP was used as the solvent, which were stirred for 30 minutes with the rotary degassing machine (Hongyi). The stirred slurry was left to rest, and the change in viscosity over time was observed.

In particular, the benzenediol additive can form the stable structure as shown in Formula (I) below:

X—O^{●} Formula (I),
wherein X can resonate with —O^{●} to stabilize the structure of Formula (I).

### Example 12

The commercial adhesive (Solvay, 5130), the commercial carbon powder (Super P), the commercial sodium anode material (Medarui, A107S) and the benzenediol additive were mixed according to a weight ratio of 3.2:4:92:0.8, and NMP was used as the solvent, which were stirred for 30 minutes with the rotary degassing machine (Hongyi). The stirred slurry was left to rest, and the change in viscosity over time was observed.

In particular, the benzenediol additive can form the stable structure as shown in Formula (I) below:

X—O^{●} Formula (I),
wherein X can resonate with —O^{●} to stabilize the structure of Formula (I).

### Comparative Example 1

The polyacrylonitrile copolymer used as the anti-gel additive, together with the commercial adhesive (Solvay, 5130), the commercial carbon powder (Super P), the commercial sodium anode material (Medarui, A107S) and the aldehyde additive as the auxiliary, were mixed according to a weight ratio of 0.8:3.2:4:92:10, and NMP was used as the solvent, which were stirred for 30 minutes with the rotary degassing machine (Hongyi). The stirred slurry was left to rest, and the change in viscosity over time was observed.

Compared to Examples 1 to 12, the aldehyde additive used in Comparative Example 1 cannot form the stable structure as shown in Formula (I) below:

X—O^{●} Formula (I).

### Comparative Example 2

The polyacrylonitrile copolymer used as the anti-gel additive, together with the commercial adhesive (Solvay, 5130), the commercial carbon powder (Super P), the commercial sodium anode material (Medarui, A107S) and the aldehyde additive as the auxiliary, were mixed according to a weight ratio of 0.8:3.2:4:92:20, and NMP was used as the solvent, which were stirred for 30 minutes with the rotary degassing machine (Hongyi). The stirred slurry was left to rest, and the change in viscosity over time was observed.

Compared to Examples 1 to 12, the aldehyde additive used in Comparative Example 2 cannot form the stable structure as shown in Formula (I) below:

X—O^{●} Formula (I).

### Comparative Example 3

The polyacrylonitrile copolymer used as the anti-gel additive, together with the commercial adhesive (Solvay, 5130), the commercial carbon powder (Super P), the commercial sodium anode material (Medarui, A107S) and the ketone additive as the auxiliary, were mixed according to a weight ratio of 0.8:3.2:4:92:10, and NMP was used as the solvent, which were stirred for 30 minutes with the rotary degassing machine (Hongyi). The stirred slurry was left to rest, and the change in viscosity over time was observed.

Compared to Examples 1 to 12, the ketone additive used in Comparative Example 3 cannot form the stable structure as shown in Formula (I) below:

X—O^{●} Formula (I).

### Comparative Example 4

The polyacrylonitrile copolymer used as the anti-gel additive, together with the commercial adhesive (Solvay, 5130), the commercial carbon powder (Super P), the commercial sodium anode material (Medarui, A107S) and the ketone additive as the auxiliary, were mixed according to a weight ratio of 0.8:3.2:4:92:80, and NMP was used as the solvent, which were stirred for 30 minutes with the rotary degassing machine (Hongyi). The stirred slurry was left to rest, and the change in viscosity over time was observed.

Compared to Examples 1 to 12, the ketone additive used in Comparative Example 4 cannot form the stable structure as shown in Formula (I) below:

X—O^{●} Formula (I).

### Comparative Example 5

The polyacrylonitrile copolymer used as the adhesive, together with the commercial carbon powder (Super P) and the commercial sodium anode material (Medarui, A107S), were mixed according to a weight ratio of 4:4:92, and NMP was used as the solvent, which were stirred for 30 minutes with the rotary degassing machine (Hongyi). The stirred slurry was left to rest, and the change in viscosity over time was observed.

Compared to Examples 1 to 12, Comparative Example 5 was not added with any additive that can form the stable structure as shown in Formula (I) below:

X—O^{●} Formula (I).

### Comparative Example 6

The commercial adhesive (Solvay, 5130), the commercial carbon powder (Super P), the commercial sodium anode material (Medarui, A 107S) and the aldehyde additive were mixed according to a weight ratio of 3.6:4:92:0.4, and NMP was used as the solvent, which were stirred for 30 minutes with the rotary degassing machine (Hongyi). The stirred slurry was left to rest, and the change in viscosity over time was observed.

Compared to Examples 1 to 12, the aldehyde additive used in Comparative Example 6 cannot form the stable structure as shown in Formula (I) below:

X—O^{●} Formula (I).

### Comparative Example 7

The commercial adhesive (Solvay, 5130), the commercial carbon powder (Super P), the commercial sodium anode material (Medarui, A 107S) and the aldehyde additive were mixed according to a weight ratio of 3.2:4:92:0.8, and NMP was used as the solvent, which were stirred for 30 minutes with the rotary degassing machine (Hongyi). The stirred slurry was left to rest, and the change in viscosity over time was observed.

Compared to Examples 1 to 12, the aldehyde additive used in Comparative Example 7 cannot form the stable structure as shown in Formula (I) below:

X—O^{●} Formula (I).

### Comparative Example 8

The commercial adhesive (Solvay, 5130), the commercial carbon powder (Super P), the commercial sodium anode material (Medarui, A107S) and polyacrylonitrile (PAN) were mixed according to a weight ratio of 3.6:4:92:0.4, and NMP was used as the solvent, which were stirred for 30 minutes with the rotary degassing machine (Hongyi). The stirred slurry was left to rest, and the change in viscosity over time was observed.

Compared to Examples 1 to 12, Comparative Example 8 was not added with any additive that can form the stable structure as shown in Formula (I) below:

X—O^{●} Formula (I).

### Comparative Example 9

The commercial adhesive (Solvay, 5130), the commercial carbon powder (Super P), the commercial sodium anode material (Medarui, A107S) and PAN were mixed according to a weight ratio of 3.2:4:92:0.8, and NMP was used as the solvent, which were stirred for 30 minutes with the rotary degassing machine (Hongyi). The stirred slurry was left to rest, and the change in viscosity over time was observed.

Compared to Examples 1 to 12, Comparative Example 9 was not added with any additive that can form the stable structure as shown in Formula (I) below:

X—O^{●} Formula (I).

### Comparative Example 10

PAN, the commercial carbon powder (Super P) and the commercial sodium anode material (Medarui, A107S) were mixed according to a weight ratio of 4:4:92, and NMP was used as the solvent, which were stirred for 30 minutes with the rotary degassing machine (Hongyi). The stirred slurry was left to rest, and the change in viscosity over time was observed.

Compared to Examples 1 to 12, Comparative Example 10 was not added with any additive that can form the stable structure as shown in Formula (I) below:

X—O^{●} Formula (I).

### Comparative Example 11

The commercial adhesive (Solvay, 5130), the commercial carbon powder (Super P) and the commercial sodium anode material (Medarui, A107S) were mixed according to a weight ratio of 4:4:92, and NMP was used as the solvent, which were stirred for 30 minutes with the rotary degassing machine (Hongyi). The stirred slurry was left to rest, and the change in viscosity over time was observed.

Compared to Examples 1 to 12, Comparative Example 11 was not added with any additive that can form the stable structure as shown in Formula (I) below:

X—O^{●} Formula (I).

### Test Examples

The changes in viscosity of the slurries of the above Examples 1 to 22 and Comparative Examples 1 to 11 over time and whether gelation occurred were measured. The measurement results are shown in Table 1 below.

TABLE 1

| | 0 hr | 2 hr | 6 hr | 9 hr | 12 hr | 24 hr | 48 hr |
|---|---|---|---|---|---|---|---|
| Example 1 | 3860 | 4781 | 10680 | | | Gel | |
| Example 2 | 13238 | 35878 | Gel | | | | |
| Example 3 | 103 | 198 | 76 | | | Gel | |
| Example 4 | | | 234 | 267.9 | 186 | 329.3 | 3237 |
| Example 5 | | | 1994 | — | — | 1064 | — |
| Example 6 | | | 865 | — | — | 694.5 | — |
| Example 7 | 1321 | 368 | 486 | | | Gel | |
| Example 8 | 12100 | 12912 | Gel | | | | |
| Example 9 | 1395 | 410 | 396 | | | Gel | |
| Example 10 | 2856 | 763 | 1736 | | | 57490 | Gel |
| Example 11 | 2093 | 3181 | 1327 | | | 19440 | Gel |
| Example 12 | 3191 | 3680 | 1293 | | | 1473 | 2130 |
| Comparative | | | 169 | 171.3 | Gel | — | — |
| Example 1 | | | | | | | |
| Comparative | 90510 | Gel | | | | | |
| Example 2 | | | | | | | |
| Comparative | 1470 | 930 | Gel | | | | |
| Example 3 | | | | | | | |
| Comparative | 223 | 521 | Gel | | | | |
| Example 4 | | | | | | | |
| Comparative | | | 78.14 | 225.1 | 420 | 18000 | Gel |
| Example 5 | | | | | | | |
| Comparative | 21320 | Gel | | | | | |
| Example 6 | | | | | | | |
| Comparative | 16732 | 36740 | Gel | | | | |
| Example 7 | | | | | | | |
| Comparative | 2136 | 7162 | Gel | | | | |
| Example 8 | | | | | | | |
| Comparative | 3721 | 8558 | Gel | | | | |
| Example 9 | | | | | | | |
| Comparative | 11330 | 15220 | Gel | | | | |
| Example 10 | | | | | | | |
| Comparative | Gel | | | — | — | — | — |
| Example 11 | | | | | | | |

The viscosity unit in Table 1 is cps, and Gel represents that gelation has been observed, so the viscosity cannot be measured.

As shown in Table 1 above, compared to Comparative Examples 1 to 11, Examples 1 to 12 contain specific compounds or polymers, so that the prepared electrode slurries have better viscosity properties. In particular, the compounds or polymers included in Examples 1 to 12 can form the stable structure as shown in the following Formula (I): X—O^{●} Formula (I), wherein X can resonate with —O^{●} to stabilize the structure of Formula (I), thereby making the electrode slurries prepared have better viscosity properties. Relatively speaking, the compounds or polymers included in Comparative Examples 1 to 11 are unable to form the above structure, so that the prepared electrode slurries have poor viscosity properties.

The present invention has been disclosed in preferred embodiments above. However, those skilled in the art should understand that the embodiments are only used to illustrate the present invention and should not be construed as limiting the scope of the present invention. It should be noted that any changes and substitutions that are equivalent to these embodiments should be considered to be within the scope of the present invention. Therefore, the protection scope of the present invention shall be defined by the appended claims.

While the present disclosure has been described by means of specific embodiments, numerous modifications and variations could be made thereto by those skilled in the art without departing from the scope and spirit of the present disclosure set forth in the claims.

What is claimed is:

1. An electrode slurry for an electrochemical energy storage device, comprising:
one or more compounds or polymers that can form a stable structure of Formula (I) as shown below:
X—O^{●} Formula (I)
wherein X can resonate with —O^{●} to stabilize the structure of Formula (I).

2. The electrode slurry of claim 1, wherein X is an organic moiety selected from 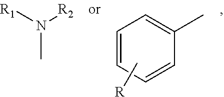
wherein R₁ and R₂ are substituents selected from the group consisting of linear or cyclic alkyl groups, aryl groups and derivatives thereof,
wherein R is a substituent selected from the group consisting of alkyl group, carboxyl group, carbonyl group, hydroxyl group and derivatives thereof.

3. The electrode slurry of claim 1, further comprising lithium, sodium or a compound thereof.

4. The electrode slurry of claim 1, further comprising a polymer or a copolymer derived from vinylidene fluoride (VDF) and/or acrylonitrile (AN) monomers.

5. The electrode slurry of claim 4, wherein the copolymer has a structure as shown below: 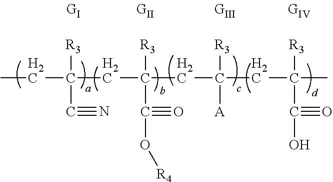
wherein:
G_{I} is derived from acrylonitrile;
G_{II} is derived from acrylate or methacrylate, and R₄ is a linear alkyl group;
G_{III} is derived from a vinylactam compound, A is a cyclic amide group;
G_{IV} is derived from acrylic acid or methacrylic acid;
wherein R₃ is H or CH₃;
wherein a number of a repeating unit of the copolymer meets the following conditions:
$$\frac{a}{a + b + c + d} > 0 ‵ \frac{b}{a + b + c + d} > 0 ‵ \frac{c}{a + b + c + d} \geq 0 ‵ \frac{d}{a + b + c + d} \geq 0.$$

6. The electrode slurry of claim 5, wherein based on a total weight of the copolymer, G_{I} is 50 to 98 wt %, G_{II} is 0.5 to 20 wt %, G_{III} is 0.5 to 20 wt %, and G_{IV} is 0.5 to 20 wt %.

7. The electrode slurry of claim 1, wherein based on a solid weight of the electrode slurry, the compound or the polymer is 0.001 to 10 wt %.

8. The electrode slurry of claim 1, wherein the compound or the polymer is selected from the group consisting of compounds containing a phenolic moiety, compounds containing an aminoxide moiety, phenols and derivatives thereof or derived polymers thereof.

9. The electrode slurry of claim 8, wherein the compound or the polymer is selected from the group consisting of 4-hydroxy-2,2,6,6-tetramethyl-1-piperidine oxide, 4-hydroxy-2,2,6,6-tetramethyl-1-piperidine oxide, tetramethylpiperidine oxide, phenol, polyphenols, hydroquinone and hydroquinone monomethyl ether and derivatives thereof or derived polymers thereof.
